(19) United States
(12) Patent Application Publication
(10) Pub. No.: US 2008/0229873 A1
(43) Pub. Date: Sep. 25, 2008

(54) Shift Member and Gear Shifting Arrangement Comprising the Shift Member

(75) Inventor: Daniel Jansson, Eskilstuna (SE)

Correspondence Address: WRB-IP LLP, 1217 KING STREET, ALEXANDRIA, VA, 22314, US

(73) Assignee: Volvo Construction Equipment Holding Sweden AB, Eskilstuna (SE)

(21) Appl. No.: 12/089,742

(22) PCT Filed: Nov. 10, 2005
(86) PCT No.: PCT/SE05/01699

§ 371 Date: Apr. 10, 2008

(51) Int. Cl. F16H 53/00; F16H 25/12

(52) U.S. Cl. 74/567; 74/57

(57) ABSTRACT

A shift member for gear shifting in a gear box is provided. The shift member is cylindrical and it includes an arrangement for activating different gears at different angular positions of the shift member and an actuation part for effecting pivoting of the shift member when actuated. The shift member actuation part includes an actuation structure with angularly spaced depressed portions and projecting portions. A gear shifting arrangement is also provided and includes the shift member and an actuation system including at least one actuation member for selective engagement with the actuation structure at different positions in the circumferential direction of the shift member for a stepwise rotation of the shift member.

### BACKGROUND AND SUMMARY

An aspect of the present invention relates to a shift member for gear shifting in a gear box, the shift member is cylindrical and it comprises means for achieving different gears at different angular positions of the shift member and an actuation part for effecting pivoting of the shift member when actuated. An aspect of the invention also relates to a gear shifting arrangement comprising such a shift member.

An aspect of the invention is related to gear shifting in a vehicle gear box and particularly for heavy duty vehicles like trucks and work vehicles. The term work vehicle comprises different types of material handling vehicles like construction machines, such as an articulated hauler, a wheel loader, a backhoe loader, a motor grader and an excavator.

An aspect of the invention regards gear shifting in a gear box of a non-planetary type. A sleeve, either synchronized or non-synchronized, is movably arranged on a shaft between two adjacent freely rotating gear wheels. By moving the sleeve into engagement with one of the gear wheels, it will be rotationally locked to the shaft and a particular gear is selected. A shift element, or selector fork, is arranged in contact with the sleeve for moving the sleeve accordingly.

A gear shifting arrangement comprising a cylindrical shift member, or barrel cam, is known for a passenger car gear box. The cylindrical shift member comprises a plurality of slots for activating different gears at different angular positions. The slots extend in the shift member circumferential direction and are mutually spaced in an axial direction of the shift member. Each slot comprises two axially spaced sections and a shift between the axially spaced sections defines a gear shift position. Different slots have the shift at different angular positions of the cylindrical shift member.

One shift element is guided in each slot. The shift element is arranged for translational movement to and fro along a guide member in parallel with an axial direction of the cylindrical shaft member. More particularly, the shift element is configured to move an engaging sleeve to and fro in order to engage different gear wheels. By pivoting the cylindrical shift member, the shift elements are consecutively moved and the sleeves engage different gears.

An electric motor is used for indexing the shift member by a pivoting motion in the gear shifting arrangement for the passenger car gear box. In heavy duty vehicles, the gear boxes are considerably larger and a power required for shifting gears is therefore also substantially larger relative to a passenger car. Alternative solutions to indexing the shift member by means of an electric motor is therefore desired.

It is desirable to achieve a shift member, which creates conditions for a robust shifting method with fixed shift positions, especially suitable for heavy duty vehicles. Further, the shift member should be cost-efficient to manufacture with a minimum of separate parts.

According to an aspect of the present invention, a cylindrical shift member comprises means for activating different gears at different angular positions of the shift member and an actuation part for effecting pivoting of the shift member when actuated characterized in that the shift member actuation part comprises an actuation structure with angularly spaced depressed portions and projecting portions. This design creates conditions for achieving fixed shift positions in both rotational directions.

A mechanical end position may be achieved in each depression. Such design facilitates the shift control method and creates conditions for faster shifting.

According to a preferred embodiment, the actuation structure comprises a wave configuration extending in the circumferential direction of the shift member. The shift member is pivoted by actuating the wave configuration. An actuation member moved into contact with a slope in the wave configuration will pivot the shift member as it is moved along the slope towards a depression. Preferably, the wave configuration has a repetitive pattern in the circumferential direction of the shift member.

According to a further preferred embodiment, the means for activating different gears at different angular positions comprises a plurality of slots, which extend in the shift member circumferential direction and are mutually spaced in an axial direction of the shift member, that each slot comprises at least two axially spaced sections and that a shift between the axially spaced sections defines a shift event. The shift event comprises not only a gear shift position in the gear box, but also a neutral position in the gear box.

An angular position of the shift between the axially spaced sections of a particular slot coincides with an angular position of the deepest point in a depression in the actuation structure. Thus, the actuation structure (wave configuration) is adapted to the slot structure for performing the gear shifting. This design creates conditions for an effective and robust gear shifting.

It is also desirable to achieve a gear shifting arrangement which creates conditions for an improved shifting method, especially with regard to fixed shift positions, and particularly suitable for heavy duty vehicles. It is also desirable to achieve an alternative gear shifting arrangement relative to the known arrangement comprising an electric motor.

According to an aspect of the present invention, a gear shifting arrangement comprises the pivotably arranged shift member mentioned above and an actuation system comprising at least one actuation member for selective engagement with the actuation structure at different positions in the circumferential direction of the shift member for a stepwise rotation of the shift member.

According to a preferred embodiment, a spacing between points of attack of the actuation member (s) is set at a specific distance relative to a spacing between the depressed and projecting portions, respectively. By adapting the design and position (s) of the actuation member (s) to the actuation structure, an accurate and fast shifting may be achieved.

According to a further preferred embodiment, a plurality of actuation members are spaced apart in the circumferential direction of the shift member. By consecutively activating the actuation members in a specific order, shifting between the gears may be achieved.

According to a further preferred embodiment, the actuation system is hydraulic for selectively controlling the actuation member. In heavy duty vehicle gear boxes, a hydraulic system is often already present for actuation of wet clutches. Therefore, it is efficient to use the already available hydraulic system also for the gear shifting function.

Further preferred embodiments of the invention and advantages connected thereto will be apparent from the following drawings, and description.

### BRIEF DESCRIPTION OF THE DRAWINGS

The invention will be explained below, with reference to the embodiments shown on the appended drawings, wherein

FIG. 1 shows a gear shifting arrangement in a schematic, perspective view,

FIG. 2 shows a cylindrical shift member from FIG. 1 in a perspective view,

FIG. 3 shows the shift member from FIG. 1 in a side view,

FIG. 4 shows a part of the shift member from FIG. 1 in an extended plane view,

FIG. 5 shows an actuation part of the shift member from FIG. 1 and a plurality of actuation members,

FIG. 6 shows an alternative embodiment of the actuation part of FIG. 5 in a top view, and

FIG. 7 shows a hydraulic system for actuation of the actuation members and pivoting the shift member.

### DETAILED DESCRIPTION

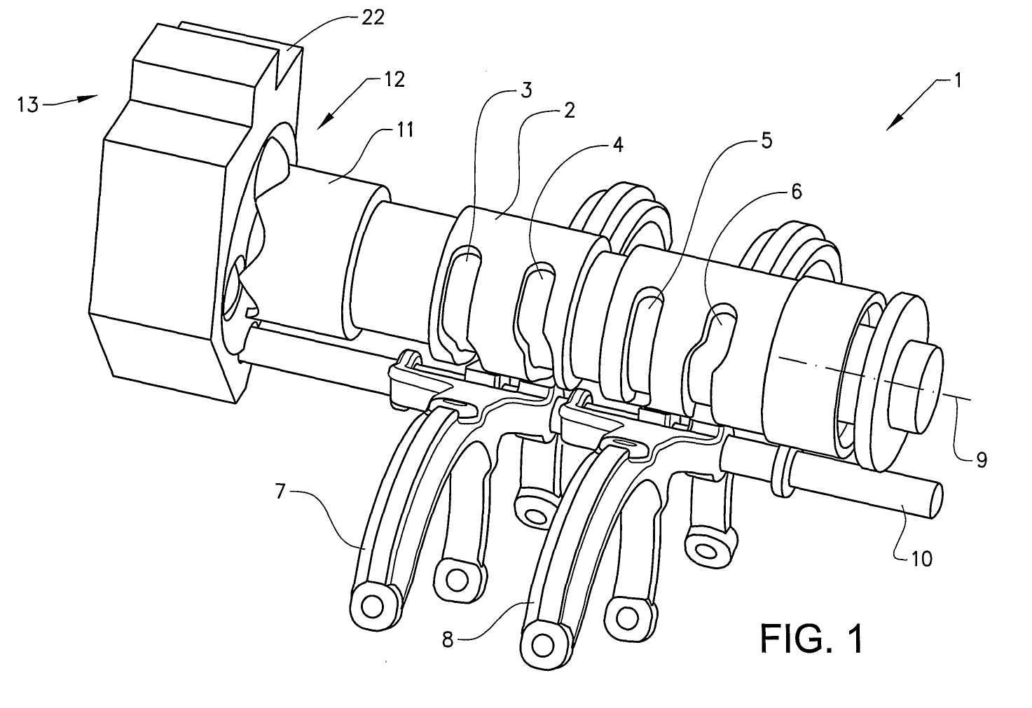

FIG. 1 shows a gear shifting arrangement 1 in a schematic, perspective view. It comprises a pivotably arranged, cylindrical shift member 2. The shift member 2 is configured for being rotated and comprises means 3, 4, 5, 6 for activating different gears in a gear box (not shown) at different angular positions of the shift member 2. Thus, the shift member 2 forms a gearbox input element of a rotary motion type. The shift member 2 is circular-cylindrical and tubular.

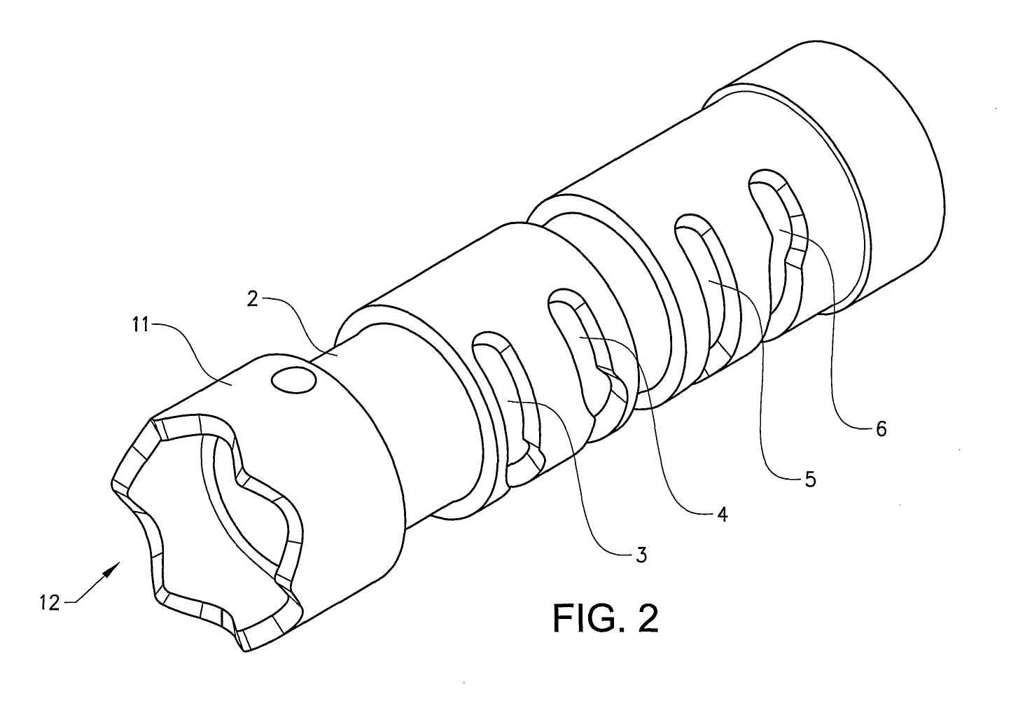

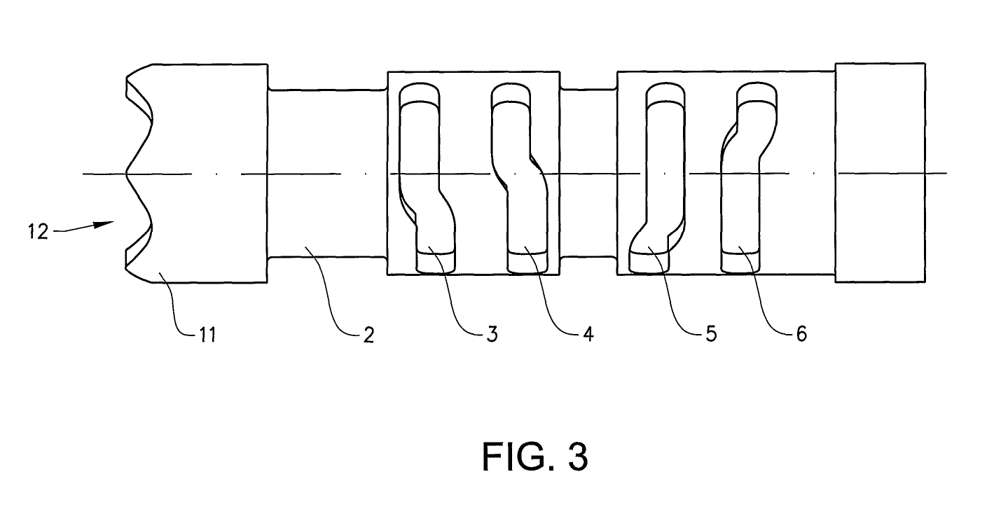

The means 3, 4, 5, 6 for activating different gears at different angular positions comprises a plurality of slots 3, 4, 5, 6, which extend in the shift member 2 circumferential direction and are mutually spaced in an axial direction of the shift member. Each slot 3, 4, 5, 6 comprises two axially spaced sections 103, 203 and 104, 204, respectively (see FIG. 2-4). A shift 303 and 304, respectively between the axially spaced sections defines a gear shift position. Different slots 3, 4 have the shift 303, 304 at different angular positions of the cylindrical shift member 2.

The gear shifting arrangement 1 comprises a plurality of shift elements 7, 8, or selector forks, configured to move engaging sleeves in a gear box (not shown) to and fro in order to engage different gear wheels. Each shift element 7, 8 is guided in one of said slots 3, 4, 5, 6. The shift elements 7, 8 are moved in an axial direction 9 of the cylindrical shift element 2 by the slot shift 303 when the shift member 2 is pivoted. More specifically, the shift elements 7, 8 are axially movably arranged on a single guide member 10, which is rigidly arranged and in parallel with the axial direction 9 of the cylindrical shift member 2.

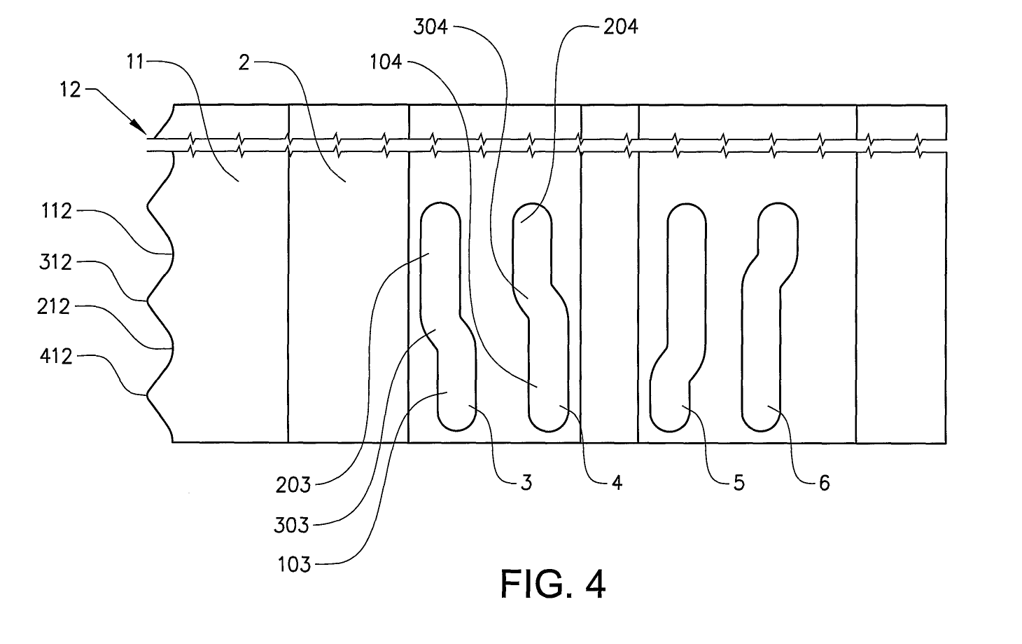

The shift member 2 further comprises an actuation part 11 for effecting pivoting of the shift member 2 in its circumferential direction when actuated. The shift member actuation part 11 comprises an actuation structure 12 at one end of the shift member 12. The actuation structure 12 comprises angularly spaced depressed, alternating portions 112, 212 and projecting portions 312, 412, see FIG. 4. There is a substantially continuous transition from a depressed portion to an adjacent projecting portion. Thus, the actuation structure 12 forms a ridge-valley configuration. An angular position of at least one of said depressed portions defines a shift event. The shift event comprises a gear shift position or neutral position in the gear box.

More specifically, the actuation structure 12 comprises a wave configuration extending in the circumferential direction of the shift member 2. The wave configuration has a repetitive pattern in the circumferential direction of the shift member 2. A number of cycles in the wave configuration correspond to the number of gears in the gear box (not shown).

Further, the wave configuration is continuous in the circumferential direction, ie there are no interruptions. In other words, the wave configuration forms a closed structure in the circumferential direction around a portion of the shift member 2. Preferably, the actuation structure 12 comprises a substantially sine-wave configuration.

Further, the actuation structure 12 faces in an axial direction of the shift member 2. Thus, the projecting portions 312, 412 project in the axial direction.

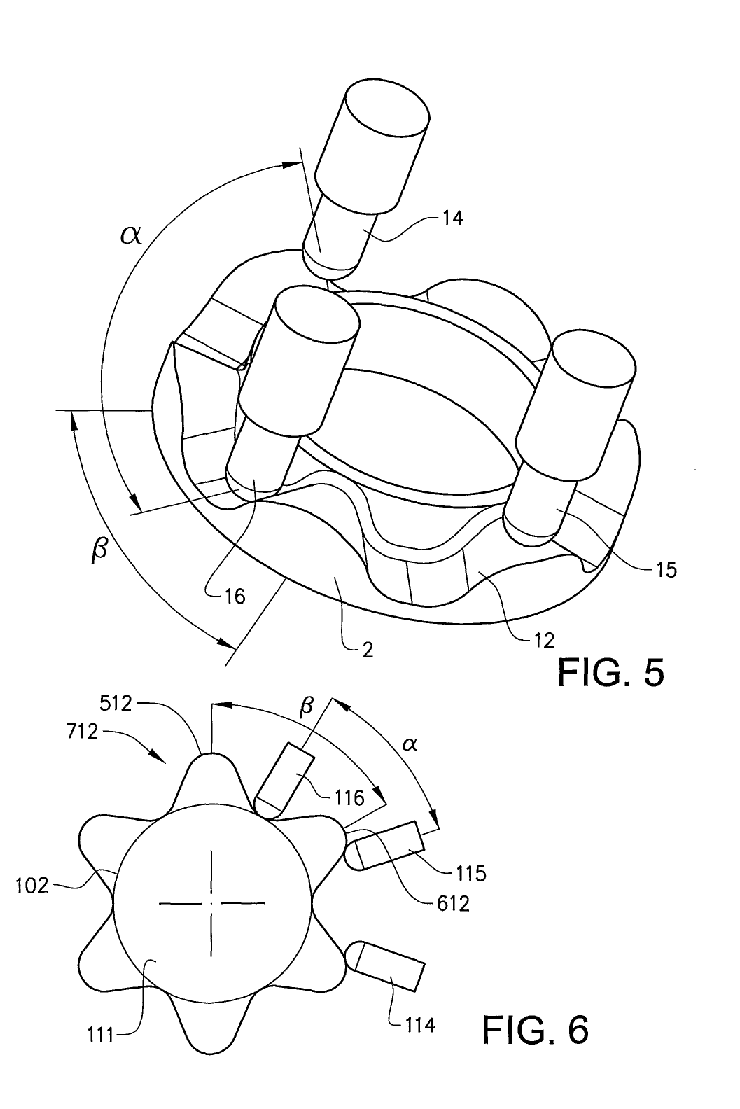

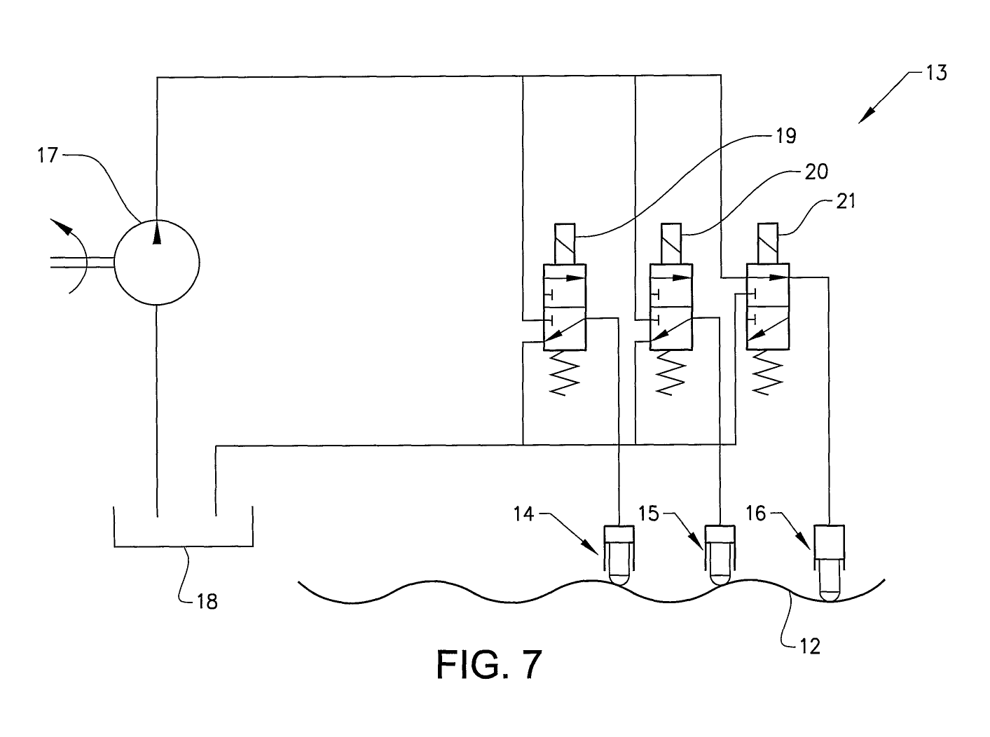

The gear shifting arrangement 1 further comprises an actuation system 13 (see FIGS. 5 and 7) comprising at least one actuation member 14, 15, 16 for selective engagement with the actuation structure 12 at different positions in the circumferential direction of the shift member 2 for a stepwise rotation of the shift member. Thus, the actuation members 14, 15, 16 act directly on the actuation structure 12. The actuation members 14, 15, 16 are non-rotationally arranged and extend in parallel to the axial direction 9 of the shift member 2. The actuation members 14, 15, 16 are positioned in set openings in a stationary housing 22, see FIG. 1.

The actuation system 13 comprises a plurality of actuation members 14, 15, 16, which are spaced apart in the circumferential direction of the shift member 2. In the shown embodiment, there are three actuation members 14, 15, 16. An angular position of the shift 303 between the axially spaced sections 103, 203 of a particular slot 3 coincides with a specific angular position of the actuation structure 12.

The actuation members 14, 15, 16 are adapted for being consecutively individually activated, wherein the cylindrical shift member 2 is stepwise pivoted and gear change is performed.

A spacing a between points of attack of the actuation members 14, 15, 16 is set at a specific value (angular distance) relative to a spacing β between the depressed and projecting portions 312, 412, respectively (see FIG. 6). More specifically, the spacing a between points of attack of the actuation members is set at a specific distance relative to a cycle of the wave configuration. The spacing a between points of attack of the actuation members 14, 15, 16 is preferably smaller than a cycle of the wave configuration and according to a preferred embodiment about ⅔ of a cycle of the wave configuration.

FIG. 6 shows an alternative embodiment to the one shown in FIG. 5. The actuation structure 712 here faces in a radial direction of the shift member 102. Thus, the projecting portions 512, 612 project in the radial direction. The actuation members 114, 115, 116 also extend in a radial direction for pivoting of the shift member 2.

According to the first embodiment, the actuation system 13 is hydraulic (see FIG. 7) and comprises a pump 17 for supplying pressurized hydraulic fluid from a container 18 to the actuation members 14, 15, 16 via valves 19,20,21. The actuation members 14, 15, 16 form hydraulic cylinders comprising hydraulically activated and translationally movable pistons. A rolling element (not shown) in the form of a ball, or small wheel, is arranged at the end of each actuation member 14, 15, 16 for contacting and rolling against the actuation structure.

The profile of the wave configuration may be varied. It may have a convex and/or concave shape. The angle of the inclined surface towards a depression sets the shifting power required by the hydraulic system.

The gear shifting arrangement 1 may be used for changing gears in different types of gear boxes. Such gear boxes are known per se and will not be discussed in detail here. According to one example, the gear box comprises a main shaft and a countershaft arranged in parallel with each other. A plurality of gear wheels run freely on the main shaft via bearings and a plurality of gear wheels are rotationally locked on the countershaft. Pairwise, one freely rotating gear wheel on the main shaft and one rotationally locked gear wheel on the countershaft are in engagement with one another. By rotationally locking different gear wheels on the main shaft to the main shaft, different gears are achieved.

The shift elements 7, 8, or selector forks, are configured to move engaging sleeves rotationally locked on the main shaft and positioned adjacent the freely rotating gear wheels to and fro in order to rotationally lock the freely rotating gear wheels to the main shaft.

The invention is not in any way limited to the above described embodiments, instead a number of alternatives and modifications are possible without departing from the scope of the following claims.

According to an alternative to the hydraulic system for actuation, a plurality of electric actuators for linear movement, or a pneumatic system may be used.

Further, the number of cycles in the wave configuration may equal the number of gears in the gear box. However, there may be more cycles in the wave configuration than the number of gears. For example one or a plurality of depressions may define a neutral position in the gear box. According one alternative, every second depression may define a neutral position. Further, said depressed portions in the actuation structure does not necessarily define a shift event, but could also have other functional or non-functional purpose.

Further, one or a plurality of said slots may have three or more axially spaced sections.

1. A shift member for gear shifting in a gear box, the shift member being cylindrical and comprising means for activating different gears at different angular positions of the shift member and an actuation part for effecting pivoting of the shift member when actuated, wherein the actuation part comprises an actuation structure with angularly spaced depressed portions and projecting portions.

2. A shift member according to claim 1, wherein an angular position of at least one of the depressed portions defines a shift event.

3. A shift member according to claim 1, wherein the actuation structure comprises a wave configuration extending in a circumferential direction of the shift member.

4. A shift member according to claim 3, wherein the wave configuration has a repetitive pattern in the circumferential direction of the shift member.

5. A shift member according to claim 3, wherein the wave configuration is continuous in the circumferential direction of the shift member.

6. A shift member according to claim 3, wherein a number of cycles in the wave configuration correspond to a number of gears in the gear box.

7. A shift member according to claim 3, wherein a number of cycles in the wave configuration is less than 12.

8. A shift member according to claim 1, wherein the actuation structure faces in an axial direction of the shift member.

9. A shift member according to claim 1, wherein the actuation structure faces in a radial direction of the shift member.

10. A shift member according to claim 1, wherein the means for activating different gears at different angular positions comprises a plurality of slots, the slots extending in a shift member circumferential direction and being mutually spaced in an axial direction of the shift member, each slot comprising at least two axially spaced sections and a shift between the axially spaced sections defines a shift event.

11. A shift member according to claim 10, wherein an angular position of the shift between the axially spaced sections of a particular slot coincides with a specific angular position of the actuation structure.

12. A shift member according to claim 10, wherein an angular position of the shift between the axially spaced sections of a particular slot coincides with an angular position of a deepest point in a depression in the actuation structure.

13. A gear shifting arrangement comprising a pivotably arranged shift member according to claim 1 and an actuation system comprising at least one actuation member for selective engagement with the actuation structure at different positions in a circumferential direction of the shift member for a stepwise rotation of the shift member.

14. A gear shifting arrangement according to claim 13, wherein a spacing between points of attack of the at least one actuation member is set at a specific distance relative to a spacing between the depressed and projecting portions, respectively.

15. A gear shifting arrangement according to claim 3, wherein the actuation structure comprises a wave configuration extending in a circumferential direction of the shift member, and wherein a spacing between points of attack of the at least one actuation member is set at a specific distance relative to a cycle of the wave configuration.

16. A gear shifting arrangement according to claim 15, wherein the actuation structure comprises a wave configuration extending in a circumferential direction of the shift member, and wherein a spacing between points of attack of the at least one actuation member is smaller than a cycle of the wave configuration.

17. A gear shifting arrangement according to claim 15, wherein a spacing between points of attack of the at least one actuation member is about ⅔ of a cycle of the wave configuration.

18. A gear shifting arrangement according to claim 13, wherein a plurality of actuation members are spaced apart in the circumferential direction of the shift member.

19. A gear shifting arrangement according to claim 18, wherein there are three actuation members.

20. A gear shifting arrangement according to claim 13, wherein the at least one actuation member comprises a piston assembly.

21. A gear shifting arrangement according to claim 13, wherein the actuation system is hydraulic for selectively controlling the actuation member.

22. A gear shifting arrangement according to claim 13, comprising it comprises a plurality of shift elements configured to move engaging sleeves to and fro in order to engage different gear wheels, and wherein the shift elements are moved by the angular shift means when the shift member is pivoted.

23. A gear shifting arrangement according to claim 22, wherein the means for activating different gears at different angular positions comprises a plurality of slots, the slots extending in a shift member circumferential direction and being mutually spaced in an axial direction of the shift member, each slot comprising at least two axially spaced sections and a shift between the axially spaced sections defines a shift event, and wherein one shift element is guided in each slot.
